(19) United States
(12) Patent Application Publication
(10) Pub. No.: US 2023/0294204 A1
(43) Pub. Date: Sep. 21, 2023

(54) METHOD AND APPARATUS FOR REMOVING LASER DEBOND RESIDUE FROM SUBSTRATE

(71) Applicant: Intel Corporation, Santa Clara, CA (US)

(72) Inventors: Jeremy ECTON, Gilbert, AZ (US); Vinith BEJUGAM, Chandler, AZ (US); Jefferson KAPLAN, Chandler, AZ (US); Yonggang LI, Chandler, AZ (US); Whitney BRYKS, Tempe, AZ (US); Samuel GEORGE, Chandler, AZ (US); Jeremy CROSS, Gilbert, AZ (US)

(21) Appl. No.: 17/698,024

(22) Filed: Mar. 18, 2022

(51) Int. Cl. B23K 26/142; B23K 26/08; B08B 3/08

(52) U.S. Cl. CPC B23K 26/142; B23K 26/0823; B08B 3/08

(57) ABSTRACT

A method includes forming a solvent on a stage, and placing, on the solvent formed on the stage, a bottom surface of a substrate on which a residue is formed, so that the residue moves away from the bottom surface of the substrate into the solvent. The method further includes removing the substrate from the solvent into which the residue is moved.

### BACKGROUND

Carrier transfer incorporating a temporary bond, debond (TBDB) process may be essential for enabling a variety of technologies including bump coplanarity, photolithography and the like. A laser can be used to ablate a bonding layer for debond, which may require a solvent to clean and remove laser ablation debris and fully dissolve an underlying adhesive polymer. A greater interest in a panel-level, TBDB process has arisen, driving a need for new tool designs or process methods that can accommodate a large panel (e.g., a substrate) with a square form factor.

To remove a residue from a substrate after laser debond for a wafer level, two approaches have been used. One, a puddle rinse approach involves a) dropping a solvent on the substrate, b) soaking, c) spinning the solvent, d) rinsing and e) drying. During the soaking, the solvent interacts with the residue on a surface of the substrate and cleans the surface. Two, a dynamic spray approach involves spraying the solvent continuously onto the substrate while the substrate spins to remove the residue from the surface of the substrate.

The puddle rinse approach may work sufficiently with a round wafer as it can effectively hold the solvent during the soaking due to surface tension and a round form factor. However, for a substrate with a square form factor, the puddle rinse approach may achieve poor coverage in corners of the substrate, resulting in remaining residue. The dynamic spray approach can be used to address the square form factor. However, a significant amount of chemistry may be required to continuously spray the substrate with the solvent, which can significantly increase cost.

### BRIEF DESCRIPTION OF THE DRAWINGS

In the drawings, like reference characters generally refer to the same parts throughout the different views. The drawings are not necessarily to scale, emphasis instead generally being placed upon illustrating the present disclosure. The dimensions of the various features or elements may be arbitrarily principles expanded or reduced for clarity. In the following description, various aspects of the present disclosure are described with reference to the following drawings, in which:

FIGS. 1A, 1B and 1C are cross-sectional diagrams of a method of removing a laser debond residue from a substrate, according to aspects of the present disclosure;

FIG. 2 is a flow diagram of the method of FIGS. 1A-1C;

FIGS. 3A, 3B, 3C and 3D are cross-sectional diagrams of a method of removing the laser debond residue from the substrate, using barriers, according to aspects of the present disclosure;

FIG. 4 is a flow diagram of the method of FIGS. 3A-3D;

FIGS. 5A, 5B, 5C and 5D are cross-sectional diagrams of a method of removing the laser debond residue from the substrate, using spray nozzles, according to aspects of the present disclosure;

FIG. 6 is a flow diagram of the method of FIGS. 5A-5D;

FIGS. 7A, 7B, 7C and 7D are cross-sectional diagrams of a method of removing the laser debond residue from the substrate, by performing hydrophobic treatment on the substrate, according to aspects of the present disclosure;

FIG. 8 is a flow diagram of the method of FIGS. 7A-7D;

FIG. 9 is a diagram of an apparatus for removing the laser debond residue from the substrate, according to aspects of the present disclosure;

FIG. 10 is a flow diagram of a method of removing the laser debond residue from the substrate, using the apparatus of FIG. 9; and

FIG. 11 is a diagram of an apparatus for removing a laser debond residue from a substrate, according to other aspects of the present disclosure.

### DETAILED DESCRIPTION

The following detailed description refers to the accompanying drawings that show, by way of illustration, specific details and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

The present disclosure relates to a method and an apparatus for removing a laser debond residue from a substrate.

A present method may include forming a solvent on a stage, and placing, on the solvent formed on the stage, a bottom surface of a substrate on which a residue is formed, so that the residue moves away from the bottom surface of the substrate into the solvent. The method may further include removing the substrate from the solvent into which the residue is moved.

In another aspect, a method pursuant to the present disclosure may include placing a top surface of a substrate on a stage and between barriers formed on the stage, and based on the top surface of the substrate being placed on the stage and between the barriers, forming a solvent between the barriers and on the stage and a bottom surface of the substrate on which a residue is formed, so that the residue moves away from the bottom surface of the substrate into the solvent. The method may further include retracting the barriers to drain, from the substrate and the stage, a portion of the solvent into which the residue is moved.

In yet another aspect, a method may include placing a top surface of a substrate on a stage, and based on the top surface of the substrate being placed on the stage, forming a solvent on a bottom surface of the substrate on which a residue is formed, so that a portion of the residue moves away from the bottom surface of the substrate into the solvent, and a remaining portion of the residue remains on corners and/or edges of the substrate. The method may further include spraying, using spray nozzles, the solvent on the corners and/or edges of the substrate to remove the remaining portion of the residue from the corners and/or edges of the substrate.

The above-detailed aspects may enable laser debond residue removal from a surface of a substrate with a square form factor and on a panel level. The aspects can further eliminate a need for a dynamic spray approach, which may translate to lower chemical consumption and lower cost.

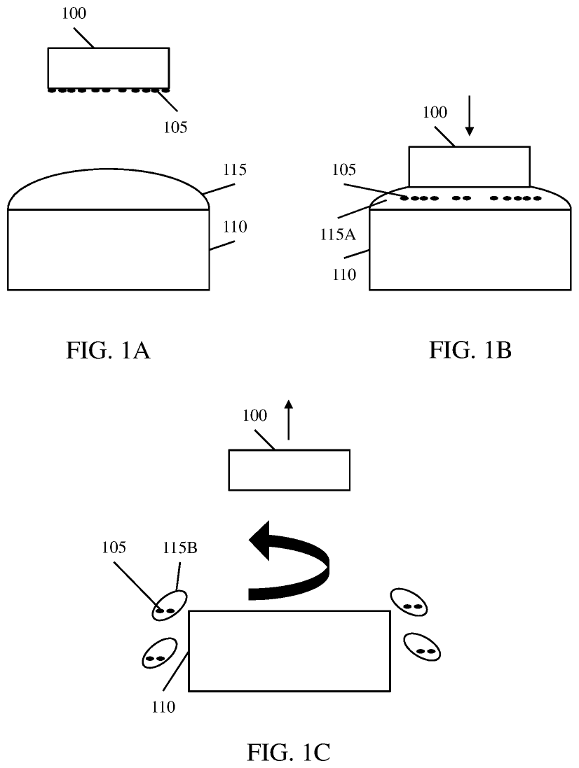

FIGS. 1A, 1B and 1C are cross-sectional diagrams of a method of removing a laser debond residue 105 from a substrate 100, according to aspects of the present disclosure.

Referring to FIG. 1A, after laser debond of the substrate 100 from another material layer (e.g., a glass carrier), the residue 105 is formed on a bottom surface of the substrate 100. The residue 105 may be formed of any material (e.g., adhesive polymer powder) that bonded the substrate 100 to the other material layer. The residue 105 may also be formed a top surface of the substrate 100 that is opposite to the bottom surface of the substrate 100.

A puddle of a solvent 115 is formed (e.g., spray coated or vapor deposited) on a stage 110 configured to hold an item (e.g., the solvent 115 and the substrate 100), and to rotate. The solvent 115 may be any proprietary solvent capable of solvating the residue 105. The stage 110 may include a wafer stage formed of any material that does not react with the solvent 115.

Further, the bottom surface of the substrate 100, on which the residue 105 is formed, is positioned to face the solvent 115 formed on the stage 110. The substrate 100 may be positioned by a robotic positioning system including a robotic arm.

Referring to FIG. 1B, the bottom surface of the substrate 100, on which the residue 105 is formed, is placed on the solvent 115 formed on the stage 110. The substrate 100 may be placed by the robotic positioning system. The bottom surface of the substrate 100 physically and directly contacts the solvent 115. As a result, the solvent 115 deforms into a shape 115A, and all of the residue 105 may move away from the bottom surface of the substrate 100 into the solvent 115.

Referring to FIG. 1C, the substrate 100 is removed from the solvent 115 into which the residue 105 is moved. The substrate 100 may be removed by the robotic positioning system. The stage 110 is then spun and rinsed to remove, from the stage 110, drops 115B of the solvent 115 and the residue 105 therein. For example, the stage 110 may be spun at a value in a range from about 1000 rotations per minute (RPM) to about 5000 RPM. Further, the removed substrate 100 is rinsed in a separate device to remove, from the substrate 100, the solvent 115 remaining on the substrate 100 and the residue 105 therein. The substrate 100 and the stage 100 may be rinsed by an organic solvent.

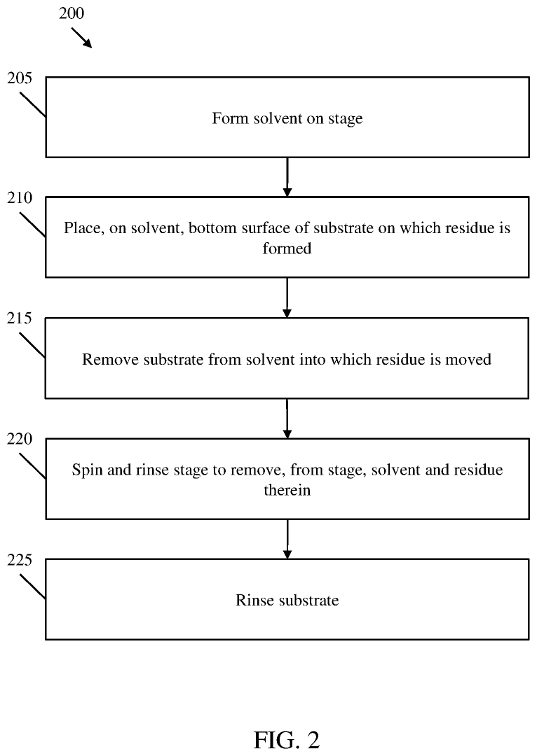

FIG. 2 is a flow diagram of the method of FIGS. 1A-1C.

Referring to FIGS. 1A-1C and 2, in operation 205, a method 200 includes forming the solvent 115 on the stage 110.

In operation 210, the method 200 includes placing, on the solvent 115 formed on the stage 110, the bottom surface of the substrate 100 on which the residue 105 is formed, so that all of the residue 105 may move away from the bottom surface of the substrate 100 into the solvent 115.

In operation 215, the method 200 includes removing the substrate 100 from the solvent 115 into which the residue 105 is moved.

In operation 220, the method 200 includes, based on the substrate 100 being removed from the solvent 115, spinning and rinsing the stage 110 to remove, from the stage 110, the solvent 115 and the residue 105 therein.

In operation 225, the method 200 includes rinsing the removed substrate 100 to remove, from the substrate 100, the solvent 115 remaining on the substrate 100 and the residue 105 therein.

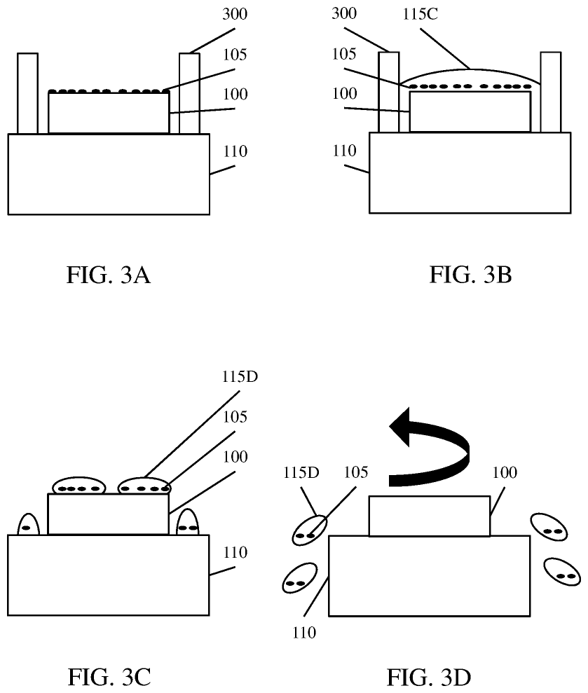

FIGS. 3A, 3B, 3C and 3D are cross-sectional diagrams of a method of removing the laser debond residue 105 from the substrate 100, using barriers 300, according to aspects of the present disclosure.

Referring to FIG. 3A, after the laser debond of the substrate 100 from the other material layer, the residue 105 is formed on the bottom surface of the substrate 100. The top surface of the substrate 100 is placed on the stage 110 and between the barriers 300 formed on the stage 110. The substrate 100 may be placed by the robotic positioning system.

The barriers 300 may be formed adjacent edges of the stage 110 and above a level of a solvent 115C of FIG. 3B to be formed on the substrate 100. The barriers 300 can form, with the stage 110, a tray for the substrate 100 and the solvent 115C. The barriers 300 may be formed of any material that does not react to the solvent 115C, and thus may be extensions of a material forming the stage 110.

Referring to FIG. 3B, the solvent 115C is formed (e.g., spray coated or vapor deposited) between the barriers 300 and on the stage 110 and the bottom surface of the substrate 100 on which the residue 105 is formed. The barriers 300 may ensure that the solvent 115C covers an entirety of the bottom surface of the substrate 100 with minimal usage of the solvent 115C. As a result, all of the residue 105 may move away from the bottom surface of the substrate 100 into the solvent 115C.

Referring to FIG. 3C, the barriers 300 are retracted to drain, from the substrate 100 and the stage 100, a portion of the solvent 115C into which the residue 105 is moved. This leaves a remaining portion 115D of the solvent 115C on the substrate 100 and the stage 110. For example, the stage 110 may include slots formed through a surface of the stage 110, and include an array of pins and blocks for mechanically moving the barriers 300 up and down, in and out of the slots.

Referring to FIG. 3D, the substrate 100 and the stage 110 are spun and rinsed to remove, from the substrate 100 and the stage 110, the remaining portion 115D of the solvent 115C and the residue 105 therein. For example, the substrate 100 and the stage 110 may be spun at a value in the range from about 1000 RPM to about 5000 RPM, and the substrate 100 and the stage 100 may be rinsed by the organic solvent.

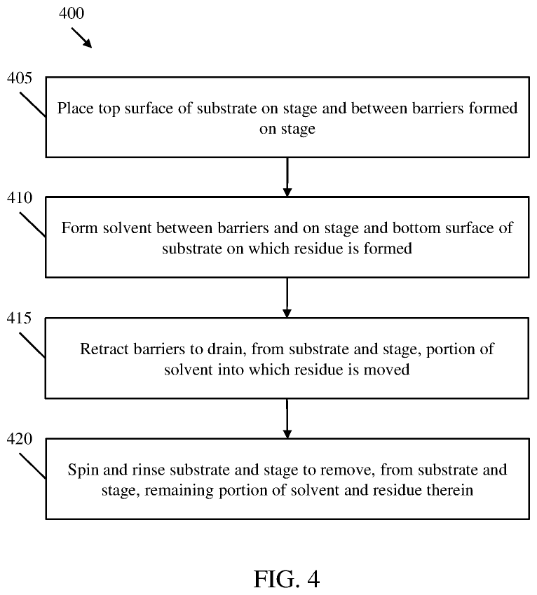

FIG. 4 is a flow diagram of the method of FIGS. 3A-3D.

Referring to FIGS. 3A-3D and 4, in operation 405, a method 400 includes placing the top surface of the substrate 100 on the stage 110 and between the barriers 300 formed on the stage 110.

In operation 410, the method 400 includes, based on the top surface of the substrate 100 being placed on the stage 110 and between the barriers 300, forming the solvent 115C between the barriers 300 and on the stage 110 and the bottom surface of the substrate 100 on which the residue 105 is formed, so that all of the residue 105 may move away from the bottom surface of the substrate 100 into the solvent 115C.

In operation 415, the method 400 includes retracting the barriers 300 to drain, from the substrate 100 and the stage 100, the portion of the solvent 115C into which the residue 105 is moved. This leaves the remaining portion 115D of the solvent 115C on the substrate 100 and the stage 110.

In operation 420, the method 400 includes spinning and rinsing the substrate 100 and the stage 110 to remove, from the substrate 100 and the stage 110, the remaining portion 115D of the solvent 115C and the residue 105 therein.

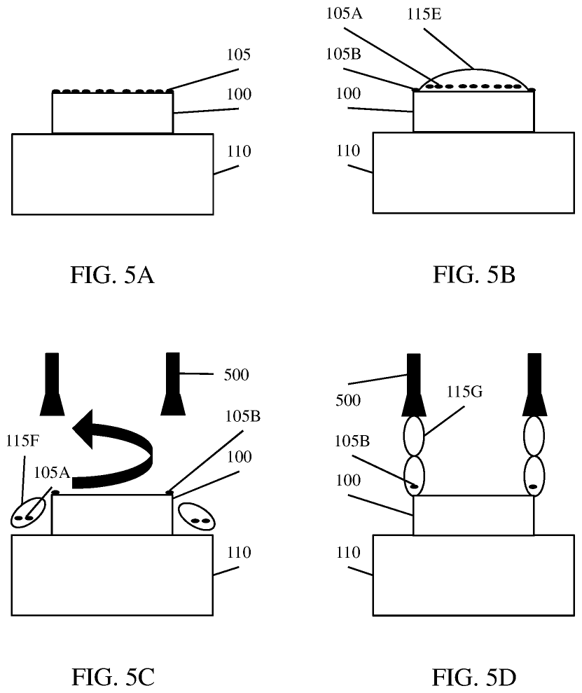

FIGS. 5A, 5B, 5C and 5D are cross-sectional diagrams of a method of removing the laser debond residue 105 from the substrate 100, using spray nozzles 500, according to aspects of the present disclosure.

Referring to FIG. 5A, after laser debond of the substrate 100 from the other material layer, the residue 105 is formed on the bottom surface of the substrate 100. The top surface of the substrate 100 is placed on the stage 110. The substrate 100 may be placed by the robotic positioning system.

Referring to FIG. 5B, a solvent 115E is formed (e.g., spray coated or vapor deposited) on the bottom surface of the substrate 100 on which the residue 105 is formed. As a result, a portion 105A of the residue 105 moves away from the bottom surface of the substrate 100 into the solvent 115E, and a remaining portion 105B of the residue 105 remains on corners and/or edges of the substrate 100. The remaining portion 105B of the residue 105 remains on the substrate 100 because, when the substrate 100 has a square form factor, the solvent 115E may have poorer coverage at the corners and/or edges of the substrate 100 as the solvent 115E may tend to drip off such areas.

Referring to FIG. 5C, the substrate 100 and the stage 110 are spun and rinsed to remove, from the bottom surface of the substrate 100, drops 115F of the solvent 115E into which the portion 105A of the residue 105 is moved. For example, the substrate 100 and the stage 110 may be spun at a value in the range from about 1000 RPM to about 5000 RPM, and the substrate 100 and the stage 100 may be rinsed by the organic solvent. Further, the position-controlled spray nozzles 500 are aligned on the corners and/or edges of the substrate 100 at which the remaining portion 105B of the residue 105 remains. The spray nozzles 500 may be aligned by the robotic positioning system.

Referring to FIG. 5D, a solvent 115G is sprayed, using the aligned spray nozzles 500, on the corners and/or edges of the substrate 100 to remove the remaining portion 105B of the residue 105 from the corners and/or edges of the substrate 100, which is not removed by the solvent 115E. This operation may be referred to as edge bead removal (EBR).

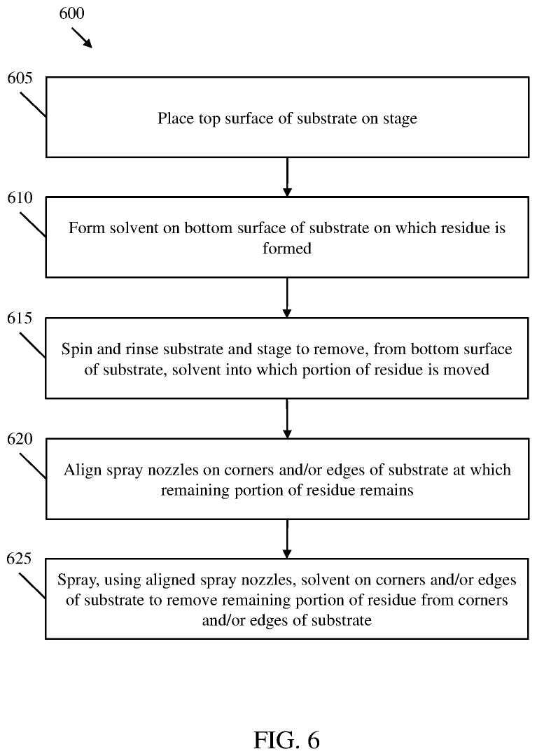

FIG. 6 is a flow diagram of the method of FIGS. 5A-5D.

Referring to FIGS. 5A-5D and 6, in operation 605, a method 600 includes placing the top surface of the substrate 100 on the stage 110.

In operation 610, the method 600 includes, based on the top surface of the substrate 100 being placed on the stage 110, forming the solvent 115E on the bottom surface of the substrate 100 on which the residue 105 is formed, so that the portion 105A of the residue 105 moves away from the bottom surface of the substrate 100 into the solvent 115E, and the remaining portion 105B of the residue 105 remains on the corners and/or edges of the substrate 100.

In operation 615, the method 600 includes spinning and rinsing the substrate 100 and the stage 110 to remove, from the bottom surface of the substrate 100, the solvent 115E into which the portion 105A of the residue 105 is moved.

In operation 620, the method 600 includes aligning the spray nozzles 500 on the corners and/or edges of the substrate 100 at which the remaining portion 105B of the residue 105 remains.

In operation 625, the method 600 includes, based on the substrate 100 and the stage 110 being spun and rinsed and based on the spray nozzles 500 being aligned, spraying, using the aligned spray nozzles 500, the solvent 115G on the corners and/or edges of the substrate 100 to remove the remaining portion 105B of the residue 105 from the corners and/or edges of the substrate 100.

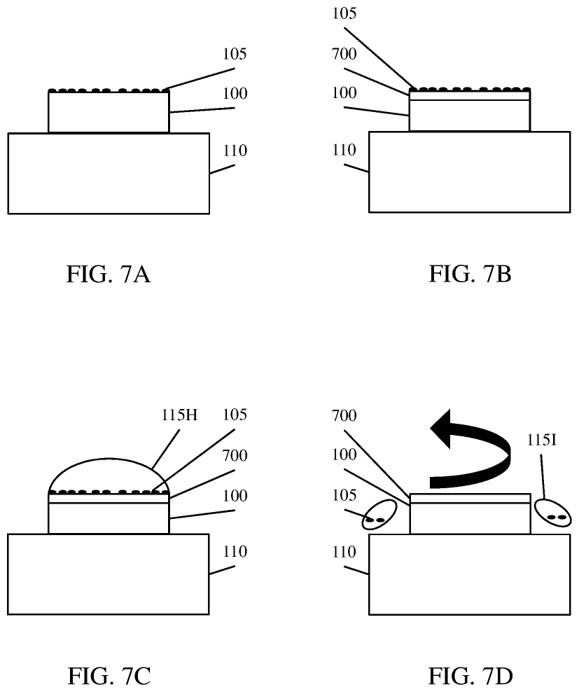

FIGS. 7A, 7B, 7C and 7D are cross-sectional diagrams of a method of removing the laser debond residue 105 from the substrate 100, by performing hydrophobic treatment 700 on the substrate 100, according to aspects of the present disclosure.

Referring to FIG. 7A, after laser debond of the substrate 100 from the other material layer, the residue 105 is formed on the bottom surface of the substrate 100. The top surface of the substrate 100 is placed on the stage 110. The substrate 100 may be placed by the robotic positioning system.

Referring to FIG. 7B, the hydrophobic treatment 700 is performed on the bottom surface of the substrate 100 on which the residue 105 is formed. The hydrophobic treatment 700 may include, for example, forming (e.g., spray coating or vapor depositing) fluorine plasma or a parylene coating on the bottom surface of the substrate 100. The hydrophobic treatment 700 may be performed on only the corners and/or edges of the substrate 100.

Referring to FIG. 7C, a solvent 115H is formed (e.g., spray coated or vapor deposited) on the bottom surface of the substrate 100 on which the hydrophobic treatment 700 is performed. The hydrophobic treatment 700 may ensure that the solvent 115H covers the entirety of the bottom surface of the substrate 100, by having a chemistry and a surface energy mismatch that holds the solvent 115H and thereby preventing the solvent 115H from dripping off the corners and/or edges of the substrate 100, even though the substrate 100 has the square form factor. As a result, all of the residue 105 may move away from the bottom surface of the substrate 100 into the solvent 115H.

Referring to FIG. 7D, the substrate 100 and the stage 110 are spun and rinsed to remove, from the bottom surface of the substrate 100, drops 1151 of the solvent 115H into which the residue 105 is moved. For example, the substrate 100 and the stage 110 may be spun at a value in the range from about 1000 RPM to about 5000 RPM, and the substrate 100 and the stage 100 may be rinsed by the organic solvent.

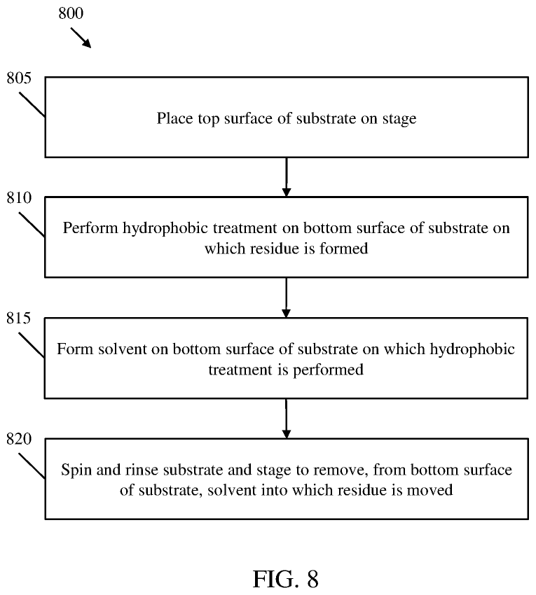

FIG. 8 is a flow diagram of the method of FIGS. 7A-7D.

Referring to FIGS. 7A-7D and 8, in operation 805, a method 800 includes placing the top surface of the substrate 100 on the stage 110.

In operation 810, the method 800 includes, based on the top surface of the substrate 100 being placed on the stage 110, performing the hydrophobic treatment 700 on the bottom surface of the substrate 100 on which the residue 105 is formed.

In operation 815, the method 800 includes forming the solvent 115H on the bottom surface of the substrate 100 on which the hydrophobic treatment 700 is performed, so that all of the residue 105 may move away from the bottom surface of the substrate 100 into the solvent 115H.

In operation 820, the method 800 includes spinning and rinsing the substrate 100 and the stage 110 to remove, from the bottom surface of the substrate 100, the solvent 115H into which the residue 105 is moved.

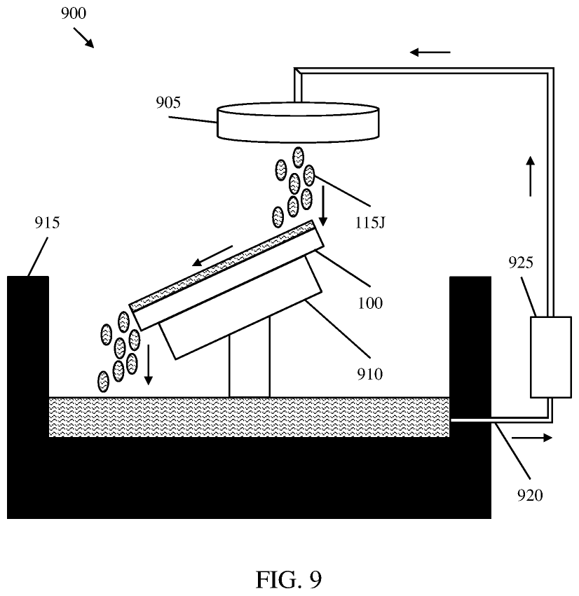

FIG. 9 is a diagram of an apparatus 900 for removing the laser debond residue 105 from the substrate 100, according to aspects of the present disclosure.

Referring to FIG. 9, the apparatus 900 includes a spray nozzle 905, a stage 910, a tank 915, a recirculation tube 920 and a filter 925.

The apparatus 900 uses gravity to coat, with a solvent 115J, the bottom surface of the angled substrate 100, and then recycles the solvent 115J to minimize chemical consumption. Use of a laminar flow of the solvent 115J across the bottom surface of the substrate 100 to remove the residue 105 may also increase a period of time in which the solvent 115J is in contact with the bottom surface of the substrate 100, as compared to a conventional spray.

In detail, the top surface of the substrate 100 is placed on the stage 910 that is angled or slanted, so that the substrate 100 is held at an angle with respect to the spray nozzle 905.

The spray nozzle 905 sprays the solvent 115J on a portion of the bottom surface of the substrate 100 on which the residue 105 is formed. The portion of the bottom surface of the substrate 100 may be adjacent to an angled edge of the substrate 100. The solvent 115J has the laminar flow from the angled edge of the substrate 100, to an opposite edge of the substrate 100, and off the opposite edge of the substrate 100. As a result, all of the residue 105 can move away from the bottom surface of the substrate 100 into the solvent 115J. In embodiments, the substrate 100 may also be angled or slanted in an opposite direction for uniform cleaning of the substrate 100.

The tank 915 collects the solvent 115J into which the residue 105 is moved, from the edge of the substrate 100 off which the solvent 115J flows.

The collected solvent 115J flows from the tank 915 through the recirculation tube 920 into the filter 925. The filter 925 filters the collected solvent 115J to remove the residue 105 from the solvent 115J.

The recirculation tube 920 recirculates, to the spray nozzle 905, the filtered solvent 115J to be resprayed on the substrate 100.

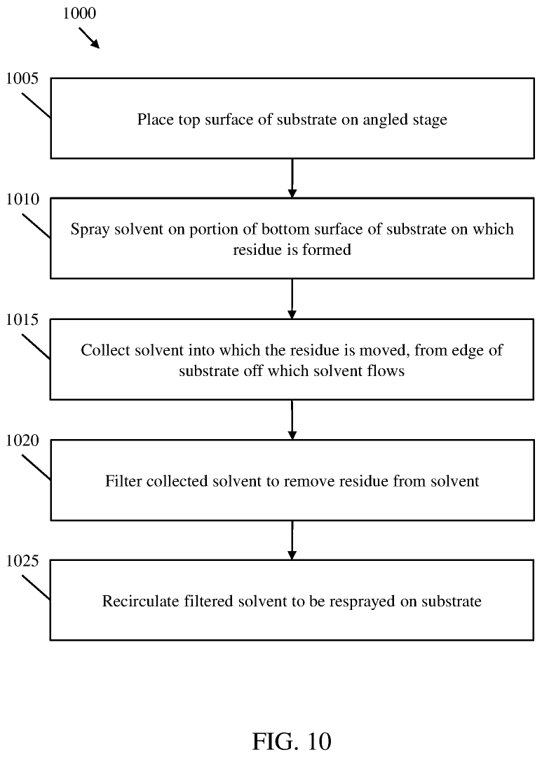

FIG. 10 is a flow diagram of a method 1000 for removing the laser debond residue 105 from the substrate 100, using the apparatus 900 of FIG. 9.

Referring to FIGS. 9 and 10, in operation 1005, the method 1000 includes placing the top surface of the substrate 100 on the angled stage 910, so that the substrate 100 is held at the angle with respect to the spray nozzle 905.

In operation 1010, the method 1000 includes, based on the top surface of the substrate 100 being placed on the angled stage 910, spraying, by the spray nozzle 905, the solvent 115J on the portion of the bottom surface of the substrate 100 on which the residue 105 is formed, so that all of the residue 105 may move away from the bottom surface of the substrate 100 into the solvent 115J.

In operation 1015, the method 1000 includes collecting, by the tank 915, the solvent 115J into which the residue 105 is moved, from the edge of the substrate 100 off which the solvent 115J flows.

In operation 1020, the method 1000 includes filtering, by the filter 925, the collected solvent 115J to remove the residue 105 from the solvent 115J.

In operation 1025, the method 1000 includes recirculating, by the recirculation tube 920, the filtered solvent 115J to be resprayed on the substrate 100.

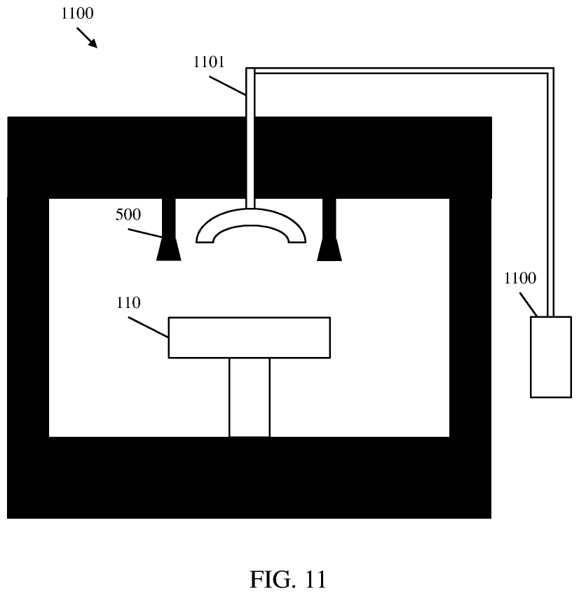

FIG. 11 is a diagram of an apparatus 1100 for removing a laser debond residue from a substrate, according to other aspects of the present disclosure.

Referring to FIG. 11, the apparatus 1100 includes the stage 110, the spray nozzles 500 and a robotic positioning system 1100 including a robotic arm 1101.

The apparatus 1100 may perform functions and steps as described above with respect to FIGS. 1A-8. In detail, the stage 110 may hold the solvent 115 and the substrate 100, may spin the solvent 115 and the substrate 100, and may move up and down the barriers 300. The spray nozzles 500 may form (e.g., spray coat or vapor deposit) the solvent 115 and the hydrophobic treatment 700, and may rinse the substrate 100 and the stage 110. The robotic positioning system 1100 may place the substrate 100 on the stage 110, may remove the substrate 100 from the stage 110, and may align the spray nozzles 500.

The methods and sequence of steps presented above are intended to be examples for removing laser debond residue from a substrate, according to the present disclosure. It will be apparent to those ordinary skilled practitioners that the foregoing process operations may be modified without departing from the spirit of the present disclosure.

To more readily understand and put into practical effect the present apparatuses and methods, particular aspects will now be described by way of examples. For the sake of brevity, duplicate descriptions of features and properties may be omitted.

### Examples

Example 1 provides a method including forming a solvent on a stage, and placing, on the solvent formed on the stage, a bottom surface of a substrate on which a residue is formed, so that the residue moves away from the bottom surface of the substrate into the solvent. The method further includes removing the substrate from the solvent into which the residue is moved.

Example 2 may include the method of example 1 and/or any other example disclosed herein, further including, based on the substrate being removed from the solvent, spinning and rinsing the stage to remove, from the stage, the solvent and the residue therein.

Example 3 may include the method of example 2 and/or any other example disclosed herein, for which the stage may be spun at a value in a range from about 1000 rotations per minute (RPM) to about 5000 RPM.

Example 4 may include the method of example 2 and/or any other example disclosed herein, for which the stage may be rinsed by an organic solvent.

Example 5 may include the method of example 1 and/or any other example disclosed herein, further including rinsing the removed substrate to remove, from the substrate, the solvent remaining on the substrate and the residue therein.

Example 6 may include the method of example 5 and/or any other example disclosed herein, for which the removed substrate may be rinsed by an organic solvent.

Example 7 provides a method including placing a top surface of a substrate on a stage and between barriers formed on the stage, and based on the top surface of the substrate being placed on the stage and between the barriers, forming a solvent between the barriers and on the stage and a bottom surface of the substrate on which a residue is formed, so that the residue moves away from the bottom surface of the substrate into the solvent. The method further includes retracting the barriers to drain, from the substrate and the stage, a portion of the solvent into which the residue is moved.

Example 8 may include the method of example 7 and/or any other example disclosed herein, further including spinning and rinsing the substrate and the stage to remove, from the substrate and the stage, a remaining portion of the solvent and the residue therein.

Example 9 may include the method of example 8 and/or any other example disclosed herein, for which the substrate and the stage may be spun at a value in a range from about 1000 rotations per minute (RPM) to about 5000 RPM.

Example 10 may include the method of example 8 and/or any other example disclosed herein, for which the substrate and the stage may be rinsed by an organic solvent.

Example 11 may include the method of example 7 and/or any other example disclosed herein, for which barriers may be formed adjacent edges of the stage and above a level of the solvent to be formed on the substrate.

Example 12 may include the method of example 7 and/or any other example disclosed herein, for which the stage and the barriers may be formed of a material that does not react to the solvent.

Example 13 may include the method of example 7 and/or any other example disclosed herein, for which the stage may include slots formed through a surface of the stage, and an array of pins and blocks configured to move the barriers in and out of the slots.

Example 14 provides a method including placing a top surface of a substrate on a stage, and based on the top surface of the substrate being placed on the stage, forming a solvent on a bottom surface of the substrate on which a residue is formed, so that a portion of the residue moves away from the bottom surface of the substrate into the solvent, and a remaining portion of the residue remains on corners and/or edges of the substrate. The method further includes spraying, using spray nozzles, the solvent on the corners and/or edges of the substrate to remove the remaining portion of the residue from the corners and/or edges of the substrate.

Example 15 may include the method of example 14 and/or any other example disclosed herein, further including spinning and rinsing the substrate and the stage to remove, from the bottom surface of the substrate, the solvent into which the portion of the residue is moved.

Example 16 may include the method of example 15 and/or any other example disclosed herein, for which the substrate and the stage may be spun at a value in a range from about 1000 rotations per minute (RPM) to about 5000 RPM.

Example 17 may include the method of example 15 and/or any other example disclosed herein, for which the substrate and the stage may be rinsed by an organic solvent.

Example 18 may include the method of example 15 and/or any other example disclosed herein, further including aligning the spray nozzles on the corners and/or edges of the substrate at which the remaining portion of the residue remains.

Example 19 may include the method of example 18 and/or any other example disclosed herein, for which the solvent may be sprayed based on the substrate and the stage being spun and rinsed and on the spray nozzles being aligned.

Example 20 provides a method including placing a top surface of a substrate on a stage, and based on the top surface of the substrate being placed on the stage, performing a hydrophobic treatment on a bottom surface of the substrate on which a residue is formed. The method further includes forming a solvent on the bottom surface of the substrate on which the hydrophobic treatment is performed, so that the residue moves away from the bottom surface of the substrate into the solvent.

Example 21 may include the method of example 20 and/or any other example disclosed herein, for which the hydrophobic treatment may include forming fluorine plasma or a parylene coating.

Example 22 may include the method of example 20 and/or any other example disclosed herein, for which the hydrophobic treatment may be performed on only corners and/or edges of the substrate.

Example 23 may include the method of example 20 and/or any other example disclosed herein, further including spinning and rinsing the substrate and the stage to remove, from the bottom surface of the substrate, the solvent into which the residue is moved.

Example 24 may include the method of example 23 and/or any other example disclosed herein, for which the substrate and the stage may be spun at a value in a range from about 1000 rotations per minute (RPM) to about 5000 RPM.

Example 25 may include the method of example 23 and/or any other example disclosed herein, for which the substrate and the stage may be rinsed by an organic solvent.

Example 26 provides a method including placing a top surface of a substrate on an angled stage, so that the substrate is held at an angle with respect to a spray nozzle, and, based on the top surface of the substrate being placed on the angled stage, spraying, by the spray nozzle, a solvent on a portion of a bottom surface of the substrate on which a residue is formed, so that the residue moves away from the bottom surface of the substrate into the solvent. The method further includes collecting, by a tank, the solvent into which the residue is moved, from an edge of the substrate off which the solvent flows.

Example 27 may include the method of example 26 and/or any other example disclosed herein, further comprising filtering, by a filter, the collected solvent to remove the residue from the solvent.

Example 28 may include the method of example 27 and/or any other example disclosed herein, further comprising recirculating, by a recirculation tube, the filtered solvent to be resprayed on the substrate.

Example 29 provides an apparatus including a stage, a spray nozzle configured to form a solvent on the stage, and a robotic positioning system configured to place, on the solvent formed on the stage, a bottom surface of a substrate on which a residue is formed, so that the residue moves away from the bottom surface of the substrate into the solvent. The robotic positioning system is further configured to remove the substrate from the solvent into which the residue is moved.

Example 30 may include the apparatus of example 29 and/or any other example disclosed herein, for which the stage may be configured to, based on the substrate being removed from the solvent, spin to remove, from the stage, the solvent and the residue therein.

Example 31 provides an apparatus including a stage, a robotic positioning system configured to place a top surface of a substrate on the stage and between barriers formed on the stage, and a spray nozzle configured to, based on the top surface of the substrate being placed on the stage and between the barriers, form a solvent between the barriers and on the stage and a bottom surface of the substrate on which a residue is formed, so that the residue moves away from the bottom surface of the substrate into the solvent. The stage is configured to retract the barriers to drain, from the substrate and the stage, a portion of the solvent into which the residue is moved.

Example 32 may include the apparatus of example 31 and/or any other example disclosed herein, for which the stage may be further configured to spin the substrate to remove, from the substrate and the stage, a remaining portion of the solvent and the residue therein.

Example 33 provides an apparatus including a stage, a robotic positioning system configured to place a top surface of a substrate on the stage, and spray nozzles configured, based on the top surface of the substrate being placed on the stage, form a solvent on a bottom surface of the substrate on which a residue is formed, so that a portion of the residue moves away from the bottom surface of the substrate into the solvent, and a remaining portion of the residue remains on corners and/or edges of the substrate. The spray nozzles are further configured to spray the solvent on the corners and/or edges of the substrate to remove the remaining portion of the residue from the corners and/or edges of the substrate.

Example 34 may include the apparatus of example 33 and/or any other example disclosed herein, wherein the stage may be configured to spin the substrate to remove, from the bottom surface of the substrate, the solvent into which the portion of the residue is moved.

Example 35 provides an apparatus including a stage, a robotic positioning system configured to place a top surface of a substrate on a stage, and a spray nozzle configured to, based on the top surface of the substrate being placed on the stage, perform a hydrophobic treatment on a bottom surface of the substrate on which a residue is formed. The spray nozzle is further configured to form a solvent on the bottom surface of the substrate on which the hydrophobic treatment is performed, so that the residue moves away from the bottom surface of the substrate into the solvent.

Example 36 may include the apparatus of example 35 and/or any other example disclosed herein, for which the stage may be configured to spin the substrate to remove, from the bottom surface of the substrate, the solvent into which the residue is moved.

Example 37 provides an apparatus including an angled stage, and a spray nozzle, a robotic positioning system configured to place a top surface of a substrate on the angled stage, so that the substrate is held at an angle with respect to the spray nozzle. The spray nozzle is configured to, based on the top surface of the substrate being placed on the angled stage, spray a solvent on a portion of a bottom surface of the substrate on which a residue is formed, so that the residue moves away from the bottom surface of the substrate into the solvent. The apparatus further includes a tank configured to collect the solvent into which the residue is moved, from an edge of the substrate off which the solvent flows.

Example 38 may include the apparatus of example 37 and/or any other example disclosed herein, further comprising a filter configured to filter the collected solvent to remove the residue from the solvent.

Example 39 may include the apparatus of example 38 and/or any other example disclosed herein, further comprising a recirculation tube configured to recirculate the filtered solvent to be resprayed on the substrate.

Example 40 provides an apparatus including spinning means, forming means for forming a solvent on the spinning means, and placing means for placing, on the solvent formed on the spinning means, a bottom surface of a substrate on which a residue is formed, so that the residue moves away from the bottom surface of the substrate into the solvent. The placing means is further for removing the substrate from the solvent into which the residue is moved.

Example 41 may include the apparatus of example 40 and/or any other example disclosed herein, for which the spinning means may be for, based on the substrate being removed from the solvent, spinning to remove, from the spinning means, the solvent and the residue therein.

Example 42 provides an apparatus including retracting means, placing means for placing a top surface of a substrate on the retracting means and between barriers formed on the retracting means, and forming means for, based on the top surface of the substrate being placed on the retracting means and between the barriers, forming a solvent between the barriers and on the retracting means and a bottom surface of the substrate on which a residue is formed, so that the residue moves away from the bottom surface of the substrate into the solvent. The retracting means is further configured to retract the barriers to drain, from the substrate and the retracting means, a portion of the solvent into which the residue is moved.

Example 43 may include the apparatus of example 42 and/or any other example disclosed herein, for which the retracting means is further for spinning the substrate to remove, from the substrate and the retracting means, a remaining portion of the solvent and the residue therein.

Example 44 provides an apparatus including spinning means, placing means for placing a top surface of a substrate on the spinning means, and forming means for, based on the top surface of the substrate being placed on the spinning means, forming a solvent on a bottom surface of the substrate on which a residue is formed, so that a portion of the residue moves away from the bottom surface of the substrate into the solvent, and a remaining portion of the residue remains on corners and/or edges of the substrate. The forming means are further for forming the solvent on the corners and/or edges of the substrate to remove the remaining portion of the residue from the corners and/or edges of the substrate.

Example 45 may include the apparatus of example 44 and/or any other example disclosed herein, wherein the spinning means is for spinning the substrate to remove, from the bottom surface of the substrate, the solvent into which the portion of the residue is moved.

Example 46 provides an apparatus including spinning means, placing means for placing a top surface of a substrate on the spinning means, and performing means for, based on the top surface of the substrate being placed on the spinning means, performing a hydrophobic treatment on a bottom surface of the substrate on which a residue is formed. The performing means is further for forming a solvent on the bottom surface of the substrate on which the hydrophobic treatment is performed, so that the residue moves away from the bottom surface of the substrate into the solvent.

Example 47 may include the apparatus of example 46 and/or any other example disclosed herein, for which the spinning means is for spinning the substrate to remove, from the bottom surface of the substrate, the solvent into which the residue is moved.

Example 48 provides an apparatus including spraying means, and placing means for placing a top surface of a substrate on an angled stage, so that the substrate is held at an angle with respect to the spraying means. The spraying means is for, based on the top surface of the substrate being placed on the angled stage, spraying a solvent on a portion of a bottom surface of the substrate on which a residue is formed, so that the residue moves away from the bottom surface of the substrate into the solvent. The apparatus further includes collecting means for collecting the solvent into which the residue is moved, from an edge of the substrate off which the solvent flows.

Example 49 may include the apparatus of example 48 and/or any other example disclosed herein, further comprising filtering means for filtering the collected solvent to remove the residue from the solvent.

Example 50 may include the apparatus of example 49 and/or any other example disclosed herein, further comprising recirculating means for recirculating the filtered solvent to be resprayed on the substrate.

It will be understood that any property described herein for a specific device may also hold for any device described herein. It will also be understood that any property described herein for a specific method may hold for any of the methods described herein. Furthermore, it will be understood that for any device or method described herein, not necessarily all the components or operations described will be enclosed in the device or method, but only some (but not all) components or operations may be enclosed.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. A method comprising:
forming a solvent on a stage;
placing, on the solvent formed on the stage, a bottom surface of a substrate on which a residue is formed, so that the residue moves away from the bottom surface of the substrate into the solvent; and
removing the substrate from the solvent into which the residue is moved.

2. The method of claim 1, further comprising, based on the substrate being removed from the solvent, spinning and rinsing the stage to remove, from the stage, the solvent and the residue therein.

3. The method of claim 2, wherein the stage is spun at a value in a range from about 1000 rotations per minute (RPM) to about 5000 RPM.

4. The method of claim 2, wherein the stage is rinsed by an organic solvent.

5. The method of claim 1, further comprising rinsing the removed substrate to remove, from the substrate, the solvent remaining on the substrate and the residue therein.

6. The method of claim 5, wherein the removed substrate is rinsed by an organic solvent.

7. A method comprising:
placing a top surface of a substrate on a stage and between barriers formed on the stage;
based on the top surface of the substrate being placed on the stage and between the barriers, forming a solvent between the barriers and on the stage and a bottom surface of the substrate on which a residue is formed, so that the residue moves away from the bottom surface of the substrate into the solvent; and
retracting the barriers to drain, from the substrate and the stage, a portion of the solvent into which the residue is moved.

8. The method of claim 7, further comprising spinning and rinsing the substrate and the stage to remove, from the substrate and the stage, a remaining portion of the solvent and the residue therein.

9. The method of claim 8, wherein the substrate and the stage are spun at a value in a range from about 1000 rotations per minute (RPM) to about 5000 RPM.

10. The method of claim 8, wherein the substrate and the stage are rinsed by an organic solvent.

11. The method of claim 7, wherein the barriers are formed adjacent edges of the stage and above a level of the solvent to be formed on the substrate.

12. The method of claim 7, wherein the stage and the barriers are formed of a material that does not react to the solvent.

13. The method of claim 7, wherein the stage comprises:
slots formed through a surface of the stage; and
an array of pins and blocks configured to move the barriers in and out of the slots.

14. A method comprising:
placing a top surface of a substrate on a stage;
based on the top surface of the substrate being placed on the stage, forming a solvent on a bottom surface of the substrate on which a residue is formed, so that a portion of the residue moves away from the bottom surface of the substrate into the solvent, and a remaining portion of the residue remains on corners and/or edges of the substrate; and
spraying, using spray nozzles, the solvent on the corners and/or edges of the substrate to remove the remaining portion of the residue from the corners and/or edges of the substrate.

15. The method of claim 14, further comprising spinning and rinsing the substrate and the stage to remove, from the bottom surface of the substrate, the solvent into which the portion of the residue is moved.

16. The method of claim 15, wherein the substrate and the stage are spun at a value in a range from about 1000 rotations per minute (RPM) to about 5000 RPM.

17. The method of claim 15, wherein the substrate and the stage are rinsed by an organic solvent.

18. The method of claim 15, further comprising aligning the spray nozzles on the corners and/or edges of the substrate at which the remaining portion of the residue remains.

19. The method of claim 18, wherein the solvent is sprayed based on the substrate and the stage being spun and rinsed and on the spray nozzles being aligned.

20. A method comprising:
placing a top surface of a substrate on a stage;
based on the top surface of the substrate being placed on the stage, performing a hydrophobic treatment on a bottom surface of the substrate on which a residue is formed; and
forming a solvent on the bottom surface of the substrate on which the hydrophobic treatment is performed, so that the residue moves away from the bottom surface of the substrate into the solvent.

21. The method of claim 20, wherein the hydrophobic treatment comprises forming fluorine plasma or a parylene coating.

22. The method of claim 20, wherein the hydrophobic treatment is performed on only corners and/or edges of the substrate.

23. The method of claim 20, further comprising spinning and rinsing the substrate and the stage to remove, from the bottom surface of the substrate, the solvent into which the residue is moved.

24. The method of claim 23, wherein the substrate and the stage are spun at a value in a range from about 1000 rotations per minute (RPM) to about 5000 RPM.

25. The method of claim 23, wherein the substrate and the stage are rinsed by an organic solvent.
